(19) United States
(12) Patent Application Publication
(10) Pub. No.: US 2025/0170993 A1
(43) Pub. Date: May 29, 2025

(54) STABILIZING JACK

(71) Applicant: Michael W. Nebel, Salina, KS (US)

(72) Inventor: Michael W. Nebel, Salina, KS (US)

(21) Appl. No.: 18/960,950

(22) Filed: Nov. 26, 2024

Related U.S. Application Data
(60) Provisional application No. 63/602,973, filed on Nov. 27, 2023.

(51) Int. Cl. B60S 9/06; B60D 1/66

(52) U.S. Cl. CPC B60S 9/06; B60D 1/66

(57) ABSTRACT

A stabilizing jack is adapted for mounting on a single frame member of a trailer. The stabilizing jack includes a base channel, a drive screw rotatably mounted within the base channel and a lift leg connected at an upper end to a screw follower threadingly coupled to the drive screw such that rotation of the screw raises and lowers the lift leg. A stabilizing leg connected between the base channel and the lift leg provides support for the leg in the extended position. A stabilizing bracket projecting upward from a central web of the base channel is adapted for mounting to a trailer frame member. The stabilizing jack includes a mounting plate for fastening to the underside of the trailer frame member. Annular spacers on the screw follower are engaged by the stabilizing leg when retracted to resist rotation of the screw.

### CROSS-REFERENCE TO RELATED APPLICATIONS

This application claims the benefit of U.S. Provisional Patent Application Ser. No. 63/602,973, entitled STABILIZING JACK, filed Nov. 27, 2023, the disclosure of which is incorporated herein in its entirety by reference.

### FIELD OF THE INVENTION

The present invention relates generally to the field of stabilizing jacks for trailers. More specifically, the present invention relates to a stabilizing jack to provide stability to a recreational vehicle when parked.

### BACKGROUND OF THE INVENTION

Stabilizing jacks are generally known in the art and have been used and developed for raising and lowering a recreational vehicle relative to the ground when parked. Stabilizing jacks are used when the trailer or a recreational vehicle is parked or stationary and the towing vehicle, such as a pickup truck, is decoupled from the trailer or recreational vehicle and the jack are used to hold the trailer generally level relative to the ground.

A wide variety of stabilizing jacks have been developed for use in stabilizing recreational vehicles, trailers and the like when parked by raising the vehicle relative to its suspension system to prevent rocking and swaying of the recreational vehicle as an occupant moves around in the vehicle. For example, U.S. Pat. No. 4,103,869 to Mesny et al. discloses a stabilizing system utilizing four separate jacks mounted in the corners of the vehicle with each jack having a separate gearmotor for extending and retracting the leg of the jack. An inner, upper end of the leg of each jack is mounted on a trunnion which rides on a worm gear or screw supported in a channel beam. A foot is connected to the outer, opposite end of the jack leg and support arms or linkages pivotally connected between a medial portion of the leg and the distal end of the channel beam. Rotation of the screw in a first direction, drives the trunnion and the upper end of the jack leg outward along the screw and the connection of the support linkages between the jack leg and the distal end of the channel beam causes the outer, opposite end of the leg to pivot downward to the ground.

U.S. Pat. No. 6,827,335 to Medberry and U.S. Pat. No. 7,249,754 to Garceau et al disclose similarly constructed jack legs with the upper, inner end of each jack leg mounted on a trunnion or block which rides on a worm gear or screw. Linkages pivotally connected between a medial portion of each jack leg and a channel beam restrict the movement of the leg causing it to pivot downward as the trunnion or block on which the upper end of the jack leg is mounted is moved outward.

In each of these systems when the jack leg is lowered to lift and stabilize the trailer, a significant portion of the load from the trailer is transmitted through the linkages. Excessive loading of the trailer can cause bending of the jack leg where it connects to the linkages, the linkages may bend or the pins connecting the linkages may fail. The upward forces acting on the jack legs are also transmitted to the beams or frame members forming the trailer frame In my prior leveling jack shown in U.S. Pat. No. 10,167,178 inner ends of separate leveling jacks mounted on beams on opposite sides of the trailer frame are interconnected by an intermediate member to reduce torque exerted on the trailer frame members or beams at the point of connection of the leveling jacks to the beams. The weight added to the leveling jacks through lengthening of the cross beams holding the drive screws and the addition of the intermediate member add weight to the overall leveling jack assembly and the trailer. The intermediate member also can interfere with utility lines extending against an underside of the trailer floor. In some instances, a spacer can be used to offset the intermediate member from the trailer bed for utility lines to travel between the intermediate member and the trailer bed, but doing so increases the weight of the jack system.

There remains a need for a lightweight stabilizing jack for travel trailers or campers that provides improved stability of the travel trailer.

### SUMMARY OF THE INVENTION

The following presents a simplified summary of the invention in order to provide a basic understanding of some aspects of the invention. This summary is not an extensive overview of the invention. It is not intended to identify critical elements of the invention or to delineate the scope of the invention. Its sole purpose is to present some concepts of the invention in a simplified form as a prelude to the more detailed description that is presented elsewhere herein. The disclosure herein is directed to a stabilizing jack designed for mounting to and stabilizing a trailer including for example travel trailers.

The stabilizing jack is adapted for mounting on a single frame member of a trailer. In one embodiment, the stabilizing jack includes a base channel having a central web and sidewalls extending downward from the central web on opposite sides thereof, and a drive screw rotatably mounted within the base channel and a screw follower assembly threadingly coupled to the drive screw. The stabilizing jack also includes a lift leg pivotally mounted at a first end to the screw follower assembly and a stabilizing member pivotally connected at a first end to the base channel and at a second end to the lift leg. A stabilizing brace or bracket is mounted on and projects upward from the central web of the base channel and is adapted for mounting to a side of a trailer frame member. The stabilizing jack preferably also includes a horizontal bracket or mounting plate for fastening to the underside of the trailer frame member to which the stabilizing truss or bracket is attached.

The stabilizing jack includes a mounting member or other mounting feature connected to and projecting from a vertical side of the stabilizing brace and in a preferred embodiment the stabilizing brace is triangular. The mounting plate is mounted on top of the web of the base channel. The triangular stabilizing brace includes a horizontal leg connected to and projecting upward from the web of the base channel, a vertical leg projecting upward from the horizontal leg at an inner end thereof, and a diagonal leg sloping downward from a peak of the vertical leg to an outer end of the horizontal leg. A notch may be formed in a lower end of the vertical leg of the stabilizing truss to receive a base flange or foot of an I-beam to which the vertical mounting plate is attached.

In a preferred embodiment, the screw follower of the stabilizing jack includes first and second spacers mounted on a trunnion threadingly coupled to the drive screw. The spacers are mounted within the base channel and support the screw follower as the lift leg and stabilizing leg are extended and retracted relative to the base channel. When the lift leg and stabilizing leg are retracted and raised to a stored position, the lift leg nests within the stabilizing leg and edges of sidewalls of the stabilizing leg engage the periphery of an aligned spacer of the screw follower to act as a brake resisting rotation of the drive screw to prevent inadvertent extension of deployment of the lift leg and stabilizing leg.

### BRIEF DESCRIPTION OF THE DRAWINGS

FIG. 1 is a fragmentary, perspective view of a trailer with two out of four stabilizing jacks shown in accordance with embodiments of the present disclosure shown secured to frame members of the trailer;

FIG. 2 is a perspective view of one of the stabilizing jacks of FIG. 1;

FIG. 3 is a rear perspective view of the stabilizing jack of FIG. 2;

FIG. 4 is a bottom perspective view of the stabilizing jack of FIG. 2;

FIG. 5 is a bottom perspective view of the base channel of the stabilizing jack of FIG. 2 with a lift leg, stabilizing member and footplate removed to show details of a drive screw and screw follower mounted within a base channel of the stabilizing jack;

FIG. 6 is a top view of the stabilizing jack of FIG. 2;

FIG. 7 is a perspective view of the stabilizing jack of FIG. 2 looking toward the inner end thereof;

FIG. 8 is an exploded, fragmentary, perspective view of the screw follower of the stabilizing jack of FIG. 2 connected to the drive screw and lift leg thereof;

FIG. 9 is a perspective view of the lift leg of the stabilizing jack of FIG. 2;

FIG. 10 is a perspective view of the stabilizing member of the stabilizing jack of FIG. 2;

FIG. 11 is a fragmentary perspective view of a trailer frame with two stabilizing jacks, of an alternative embodiment, shown secured to frame members of the trailer frame;

FIG. 12 is an enlarged and fragmentary perspective view of one of the stabilizing jacks of FIG. 11 secured to the trailer frame;

FIG. 13 is an enlarged and fragmentary perspective view of the stabilizing jack of FIG. 12;

FIG. 14 is a perspective view of the stabilizing jack of FIG. 12 form an opposite end thereof;

FIG. 15 is a bottom, perspective view of the stabilizing jack of FIG. 12;

FIG. 16 is an elevational view of an outer end of an alternative embodiment of the stabilizing jack having a wider stabilizing member; and

FIG. 17 is an exploded perspective view of an alternative embodiment of the lift leg and screw follower of the stabilizing jack.

### DETAILED DESCRIPTION OF THE PREFERRED EMBODIMENTS

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. The drawings constitute a part of this specification and include exemplary embodiments of the present invention and illustrate various objects and features thereof.

Certain terminology will be used in the following description for convenience in reference only and will not be limiting. For example, the words “upwardly,” “downwardly,” “rightwardly,” and “leftwardly” will refer to directions in the drawings to which reference is made. The words “inwardly” and “outwardly” will refer to directions toward and away from, respectively, the geometric center of the embodiment being described and designated parts thereof. Said terminology will include the words specifically mentioned, derivatives thereof and words of a similar import.

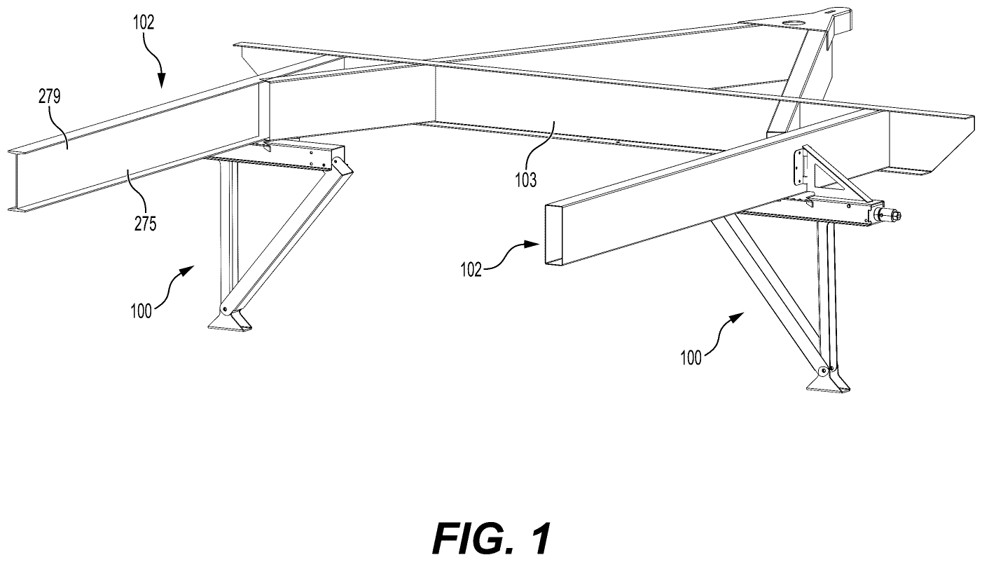

Referring to the drawings in more detail, and in particular FIGS. 1-4, the reference numeral 100 refers to a stabilizing jack of the present invention which is adapted to be secured to frame members of a recreational vehicle, such as left or right frame members 102 or cross-members or possibly lateral frame members 103 of a trailer frame 104 for a travel trailer or the like. Directional references included herein are in reference to the stabilizing jack 100 secured to the frame members of the trailer frame 104 when parked on a horizontal surface and with the trailer coupler located at a front of the trailer frame 104. The trailer frame 104 may be supported on a spring suspension system (not shown) connected to wheels (not shown). The suspension system may be configured to provide a smooth ride during travel. However, when the travel trailer frame 104 is parked or stationary, the suspension system allows the travel trailer mounted on the trailer frame 104 to rock back and forth and bounce up and down relative to the wheels as passengers move about within the travel trailer.

The stabilizing jack 100 is adapted for raising the trailer frame 104 upward relative to the wheels which removes some of the vehicle weight off the suspension system and stabilizes the travel trailer to prevent rocking or bouncing of the parked travel trailer. FIG. 1 is representative of a trailer frame 104 of a travel trailer and shows one longitudinal frame member 102 formed from an I-beam and the other a box beam for illustrative purposes. One stabilizing jack 100 is mounted proximate each corner of the trailer frame 104, namely, the front left and front right corners and the rear left and rear right corners (not shown) which substantially stabilizes the trailer frame 104 against lateral movement or swaying. It is foreseen that if strategically deployed, the stabilizing jacks 100 may be used for substantially leveling the trailer frame 104 in scenarios where the travel trailer is parked on an uneven surface. However, in scenarios when the travel trailer is parked on a substantially level surface, such as a pad, significant leveling may not be needed.

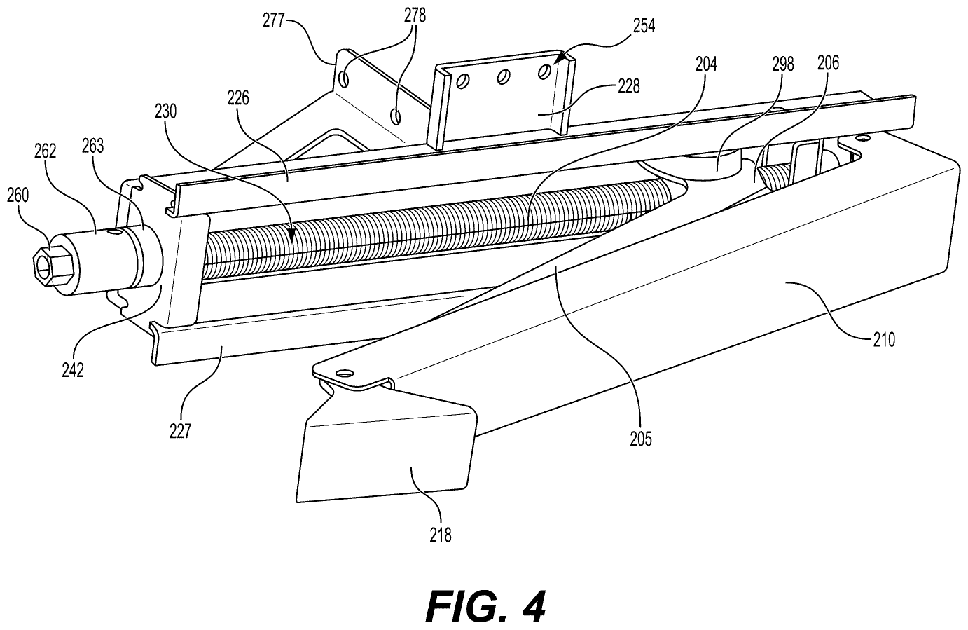

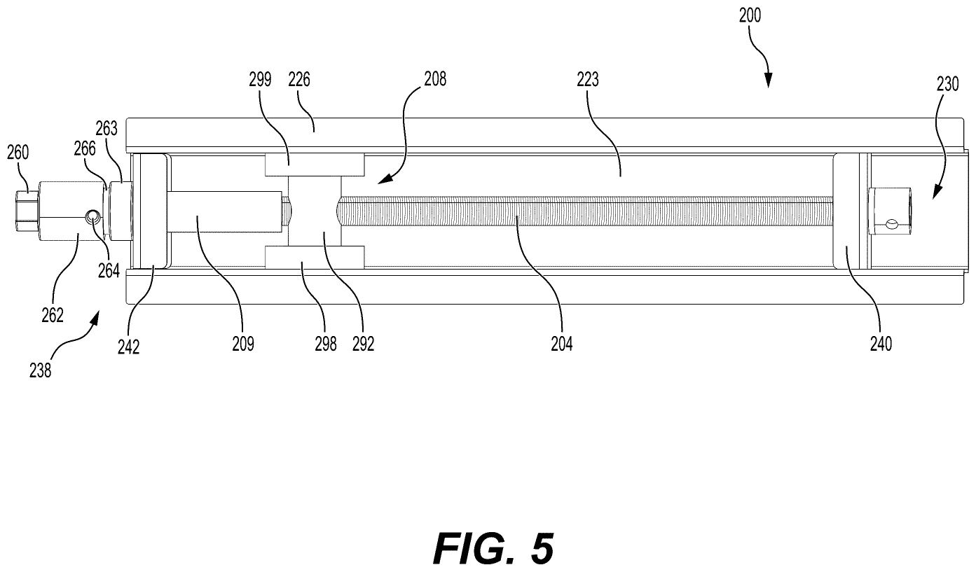

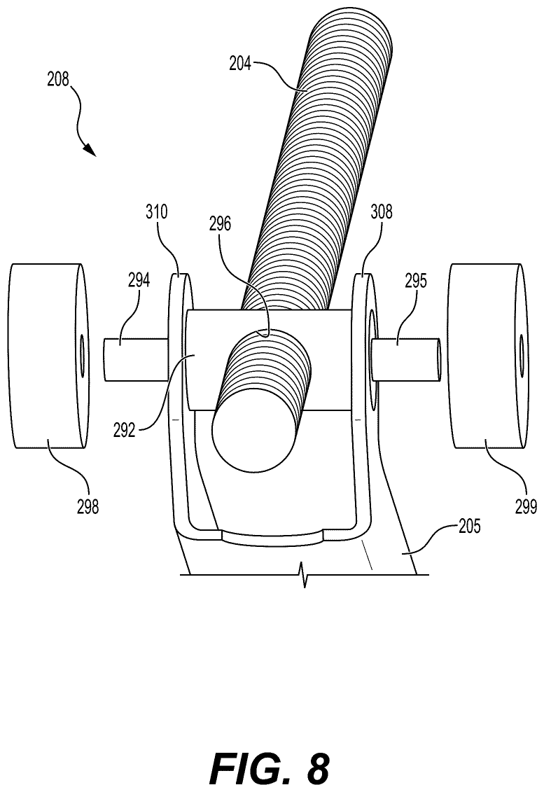

Each stabilizing jack 100 includes a base or base channel 200, a drive screw or worm gear 204 (see FIGS. 4 and 5) rotatably supported within the base channel 200, a lift leg 205 pivotally connected at a first end 206 to a screw follower assembly 208 (see FIGS. 5 and 8) which is threadingly coupled to the drive screw 204 and a strut or stabilizing member 210 pivotally connected at a first end 212 thereof to an inner end 214 of the base or base channel 200. A distal or second end 215 of the stabilizing member 210 is connected to a distal or second end 216 of the lift leg 205 and a footplate 218 by a pivot pin 207. The base 200, the lift leg 205, and the stabilizing member 210 may each be formed as a channel. In the embodiment shown, the base channel 200 is shown as a U-shaped channel with outwardly projecting flanges on the ends of the sidewalls which project from a central web of the channel. It is foreseen that the base 200 could be formed form a wide variety of other structural members including C-shaped channels with inwardly projecting flanges on the sidewalls. Similarly, the lift leg 205 and the stabilizing member 210 may be formed from structural members other than channels. In the embodiment shown, the lift leg 205 and the stabilizing member 210 are configured such that when pivoted to a retracted position, the lift leg 205 may fit within the C-shaped gap or channel of the stabilizing member 210. The footplate 218 is pivotally connected to the second end 216 of the lift leg 205 and the second end 215 of the stabilizing member 210. The base channel 200 is adapted to be mounted to a trailer frame member 102 with the inner end 214 of the base channel 200 extending underneath and toward the center of the trailer frame 104 and an outer end 238 extending proximate an outer side of the trailer frame 104. The base channel 200 houses drive screw 204 and screw follower assembly 208.

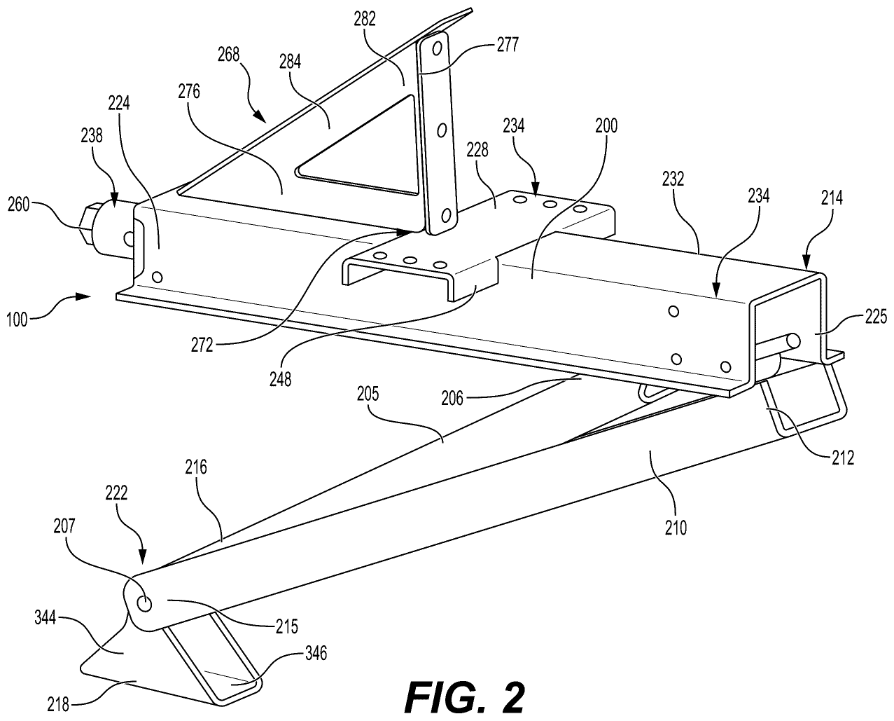

As best seen in FIGS. 2-5, the base or base channel member 200 may be formed from an elongated downwardly opening channel member comprising a horizontal web or support panel 223, downwardly extending, first and second sidewalls 224 and 225 and outwardly extending flanges 226 and 227 with an open space or channel 230 extending between the sidewalls 224 and 225. The base channel 200 may also be referred to as a track, track channel, beam, or cross beam. The drive screw 204 is rotatably mounted on an inner bearing plate 240 and outer bearing plate 242. The inner bearing plate 240 extends across the channel 230, between sidewalls 224 and 225 proximate the inner end 214 of the base channel 200 and the outer bearing plate extends across the channel 230, between sidewalls 224 and 225 proximate the outer end 238 of the base channel member 200.

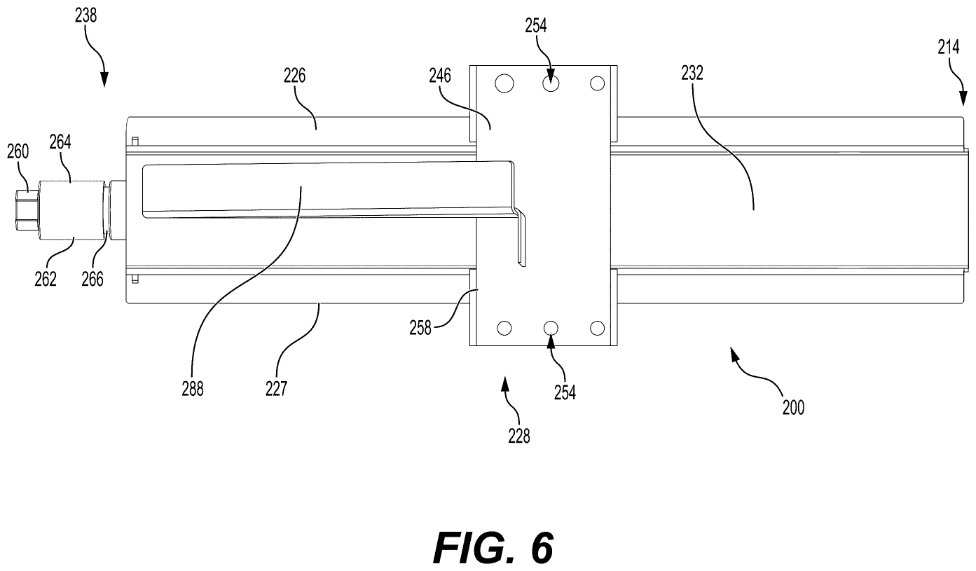

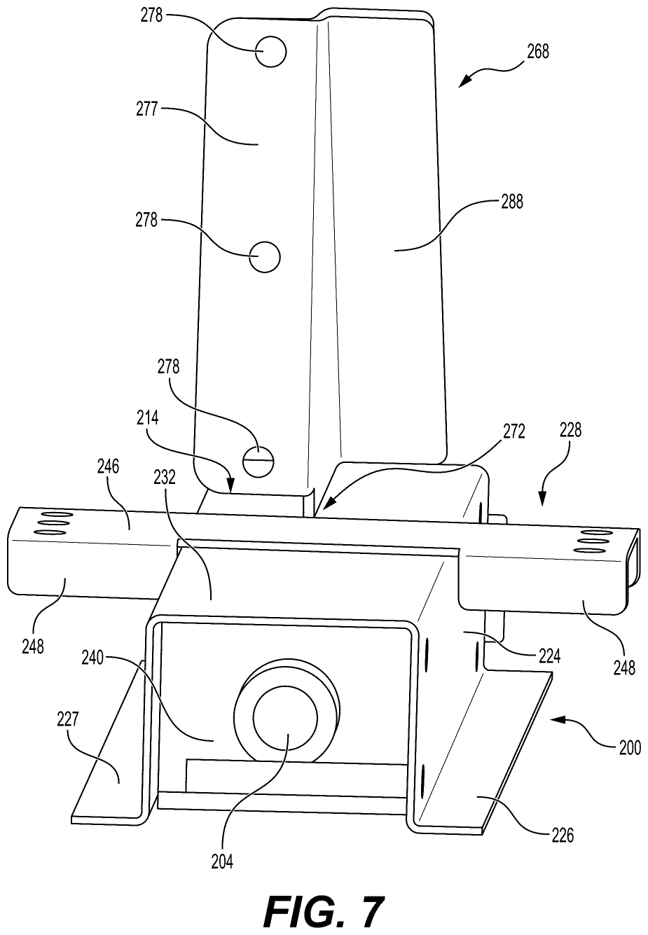

A mounting plate 228 is mounted on top of the web 223 of the base channel 200, is positioned near the longitudinal center of the base channel 200 and extends across the base channel 200 and laterally outward therefrom. The mounting plate 228 comprises a base plate 246 (see FIGS. 6 and 7), which in the embodiment shown is rectangular, secured on top of the web 223 of the base channel 200 and configured to lay perpendicular or longitudinally across the web 223 such that portions of the flat, base plate 246 partially overhang each sidewall 224 and 225. Four flanges 248 are formed on and extend downward from the edges of the base plate 246 perpendicular to the sidewalls 224 and 225 of the base channel 200. The flanges 248 provide additional strength to the mounting plate 228 to be secured to the base channel 200. The base plate 246 includes a plurality of mounting holes 254 (see FIG. 6) extending through the plate 246 proximate or adjacent to each end. Three mounting holes 254 are included adjacent each end of the plate 246 of the embodiment shown. The mounting holes 254 are sized for insertion of threaded fasteners therethrough and arranged so that threaded fasteners (e.g. a screw) may be used to secure the mounting plate 228 to the left or right frame members 102 of the trailer frame 104 to mount the stabilizing jack 100 to the trailer frame 104 with the mounting plate 246 extending in longitudinal alignment with a trailer frame member such as frame members 102, and the stabilizing jack base 200 projecting laterally outward relative to the frame member 102 to which it is attached.

In some embodiments, the base channel 200 may be mounted on the respective frame member 102 or 103 such that the base channel 200 extends perpendicular to the frame member 102 or 103 and in parallel planar alignment with a bottom surface of the frame member 102 or 103 so that the base channel 200 extends generally horizontal when the trailer is parked on level ground. It is to be understood that the base channel 200 could be formed from multiple components which are not coupled together and are separately securable to the vehicle frame.

The first end 206 of the lift leg 205 is pivotably connected to the screw follower assembly 208 which is threadingly coupled to the drive screw 204 such that as the drive screw 204 is rotated the screw follower assembly 208 advances axially along the drive screw 204. The first end 206 of the lift leg 205 moves with the screw follower assembly 208 to any position along the drive screw 204 in the channel 230. A cylindrical, annular stop 209 may be positioned on the drive screw 204 between the outer stop plate 242 and the screw follower assembly 208. The cylindrical, annular stop 209 is sized and configured to slide axially along the drive screw 204 and surrounds the drive screw 204 to act as a stop to prevent the screw follower assembly 208 from advancing too far in the outer direction towards the outer stop plate 242 of the base channel 200 to prevent the lift leg 205 from advancing past a vertical or perpendicular alignment relative to the base channel 200. The cylindrical, annular stop 209 has an inner diameter that is greater than the outer diameter of the drive screw 204 to allow the cylindrical, annular stop 209 to slide on the drive screw 204 even when the drive screw 204 is not being rotated. When the drive screw 204 is rotated, advancing the screw follower assembly 208 towards an outer end 238 (e.g. when screw follower assembly 208 is moving the lift leg 205 towards vertical) of the base channel 200, the cylindrical, annular stop 209 is advanced against the outer stop plate 242 and prevents the screw follower assembly 208 from translating further in the outer direction, thus functioning as a brake and preventing the drive screw 204 from continuing to rotate in the same direction.

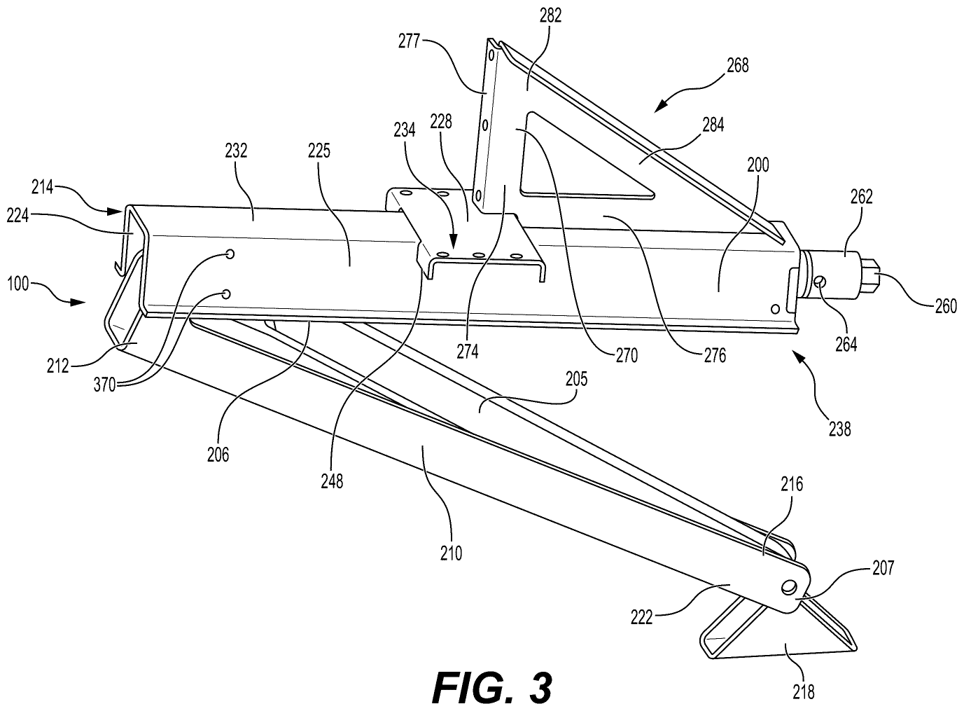

A stabilizing truss or brace 268 (see FIG. 2) is mounted on the top surface 232 of the web 223 of the base channel 200. The stabilizing brace 268 is configured as a right triangle with three sides. A horizontal side or base 276 of the brace 268 is mounted to the top surface 232 of the web 223 of the base channel 200. In the embodiment shown, the base 276 of the brace 268 extends from an outer edge 258 (see FIG. 6) of the mounting plate 228 to the outer end 238 of the base channel 200. A vertical leg 270 of the brace 268 projects upward from the base 276 at a right angle at an inner end 274 (see FIG. 3) of the base 276. A notch 272 (see FIG. 7) is formed in the base 276 and extends along the base 276 from the inner end 274 thereof and under the vertical leg 270 toward the outer end 238 of the base channel 200. In the embodiment shown, the mounting plate 228 is positioned on the top surface of the base channel 200 such that the outer edge 258 of the mounting plate 228 extends into the notch 272 and below the vertical leg 270. The notch 272 creates a gap between the vertical leg 270 and the mounting plate 228 for receiving a portion of a base flange or foot 275 of an I-beam therein. The vertical leg 270 extends upwards to a peak 282 of the triangular truss that is brace 268. A flange or a mounting member 277 extends laterally from the edge of the vertical leg 270 and extends upwards to the peak 282. The mounting member 277 includes a plurality of mounting holes 278 extending therethrough. In the embodiment shown, three mounting holes 278 are spaced apart from one another on the mounting member 277 in equally spaced vertical alignment. The mounting holes 278 are sized to receive a threaded fastener for use in securing the brace 268 and the attached base channel 200 to a frame member such as frame members 102 or 103 of the trailer frame 104. The notch 272 is sized to allow for a portion such as a flange or lateral extension 275 of an I-beam frame member 102 to extend therein 272 so that mounting member 277 may be abutted against a web 279 of the I-beam frame member 102. Threaded fasteners may be inserted through the mounting holes 278 in the mounting member 277 and through the fastener holes 234 in the mounting plate 228 to threadingly secure the stabilizing jack 100 to an I-beam frame member 102. The mounting member 277 and mounting plate 228 may also be used to secure the stabilizing jack 100 to a box beam type frame member 103.

The brace 268 includes a stabilization leg, diagonal bracing member or hypotenuse 284 which connects to the vertical leg 270 at its uppermost end or peak 282 to the base 276 at its outer end. The diagonal bracing member 284 slopes downwards from the peak 282 towards the outer end of the base 276 positioned at the outer end 238 of the base channel 200. A reinforcing rib or flange 288 may be formed along and extend laterally outward from an upper edge of the diagonal bracing member 284 to provide rigidity to the diagonal bracing member 284 and the brace 268.

The brace 268 braces the stabilizing jack 100 relative to a frame member, such as frame members 102 and 103 of the trailer frame 104, and thereby allows the base channel 200 to be substantially shorter in length than prior jack arrangements and operable without a physical connection to an additional jack positioned on an opposite side of the travel trailer or to another frame member of the trailer frame 104. Securement of the brace 268 to a frame member 102 counteracts or resists moment forces and provides substantially more front to front and side to side stability than prior arrangements. In the embodiment shown, the mounting member 277 of the brace 268 is mounted against a vertical web of an I-beam type frame member 102 or a face of a box beam type frame member 103 of the trailer frame 104 so that the stabilizing jacks 100 on either side of the frame member 102 or 103 do not need to be interconnected.

The drive screw 204 is rotatably mounted lengthwise within the base channel 200 or in axial alignment therewith and supported by the inner and outer bearing plates 240 and 242 (respectively) secured within the base channel 200 proximate opposite ends thereof. The inner bearing plate 240 extends across the channel 230 of the base channel 200 proximate the inner end 214 thereof. The outer bearing plate 242 extends across the channel 230 of the base channel 200 proximate the outer end 238 thereof. A drive feature, projection or head 260 projects outward from an outer end of the drive screw 204 and is sized and shaped for driving engagement by a matingly shaped driver or socket of a hand tool (not shown) or a matingly shaped driver or socket connected to the drive shaft of a motor (not shown). The drive head 260 preferably is formed in a shape or size corresponding to generally available tools such as socket drivers.

In a preferred embodiment, the motor is an electric motor but it is foreseen that a hydraulic motor or motors powered by other means could be utilized. In the embodiment shown, the drive head 260 is hexagonal. In the embodiment shown, a cylindrical collar 262 is positioned over and around the drive screw 204 and extends between the drive head 260 and a bearing 263 on the outer bearing plate 242. The collar 262 includes a pin hole 264 such that a pin may be inserted through both the collar 262 and the drive screw 204. One or more washers 266 may be positioned on the drive screw 204 between the bearing 263 and the collar 262. In the embodiment shown, the portion of the drive screw 204 on which the drive head 260, the collar 262, and the washers 266 are mounted extends outward from the base channel 200 and the outer bearing plate 242.

With reference to FIG. 8, the screw follower assembly 208 includes a trunnion including a trunnion body 292 with two stub axles 294 and 295 projecting outward from the trunnion body 292 and configured to received ears 308 and 310 of lift leg 205. The trunnion body 292 is cylindrical and has a greater diameter than the aligned axles 294 and 295. A threaded hole 296 is formed through the center of the trunnion body 292 and sized to threadingly receive the drive screw 204 therethrough. Annular spacers 298 and 299 are rotatably mounted on the stub axles 294 and 295 and spaced apart a distance corresponding to the width of the channel 230. The annular spacers 298 and 299 are sized with a diameter greater than the trunnion body 292. In the embodiment shown, the annular spacers 298 and 299 may be sized to roll along the downwardly facing surface of the horizontal web 223 of the base channel 200 as the screw follower assembly 208 tracks along the drive screw 204. The annular spacers 298 and 299 are positioned in between the ears 308 and 310 of lift leg 205 and the sidewalls 224 and 225 of web 223.

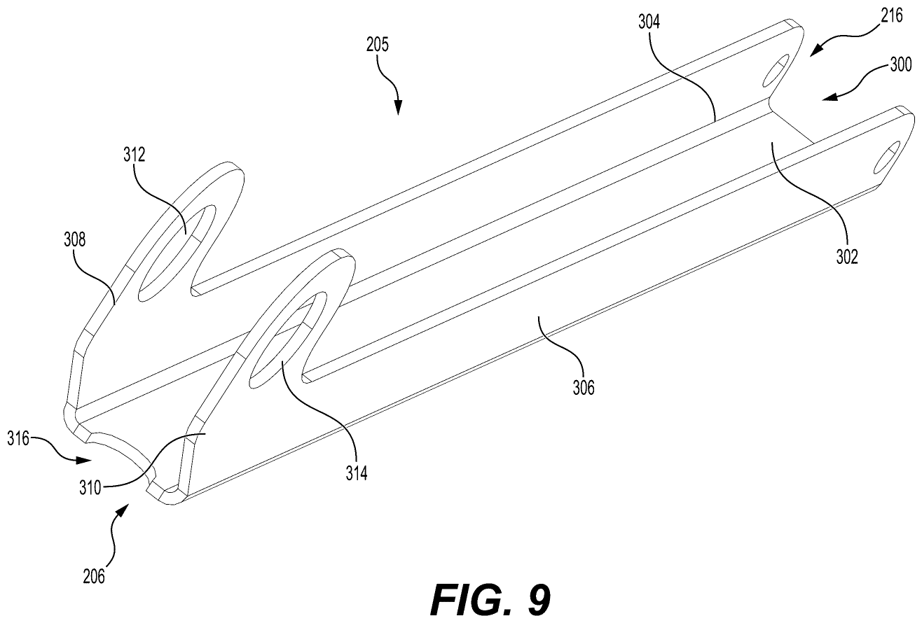

With reference to FIG. 9, the lift leg 205 is formed from a C-shaped channel 300 with a central web 302 and sidewalls 304 and 306 projecting in spaced relationship from either side of the web 302. Ears 308 and 310 are formed on inner or upper ends of each sidewall 304 and 306 respectively. A circular hole 312 and 314 is formed in each ear 308 and 310. The circular holes 312 and 314 are sized to receive ends of the trunnion body 292 allowing the lift leg 205 to pivot on the trunnion body 292 of the screw follower assembly 208. The annular spacers 298 and 299 substantially keep the trunnion body 292 aligned in the center of web 223 when the trunnion body 292 tracks along drive screw 204 and prevents either of ears 308 and 310 from shifting laterally on the trunnion body 292 and contacting drive screw 204. A notch or recess 316 is formed in the inner edge of the central web 302 of lift leg 205. The recess 316 is formed as a half circle and sized to allow the lift leg 205 to pivot to extend perpendicular to the axis of the drive screw 204 such that the web 302 of lift leg 205 does not interfere with or engage the drive screw 204. In a retracted alignment, the screw follower assembly 208 is driven inward as far as it will go which draws the second end 216 of the lift leg 205 and the second end 222 of the stabilizing member 210 upward and into the base channel 200 with the lift leg 205 nested in the channel 364 of the stabilizing member 210.

The footplate 218, connected to the second end 216 of lift leg 205 and second end 222 of stabilizing member 210 by pivot pin 207, includes a generally flat pad 346 with a pair sidewalls or ears 344 projecting upward from opposite sides of the pad 346. The pivot pin 207 extends through aligned holes in the ears 344, the second end 216 of the lift leg 205 and the second end 222 of the stabilizing member 210 and pivotally connects the footplate 218 to the stabilizing member 210 and the lift leg 205. The pin receiving holes formed in ears 344 are positioned at the center of the pad 346 so that the pad 346 generally extends horizontally when the footplate 218 is suspended above the ground.

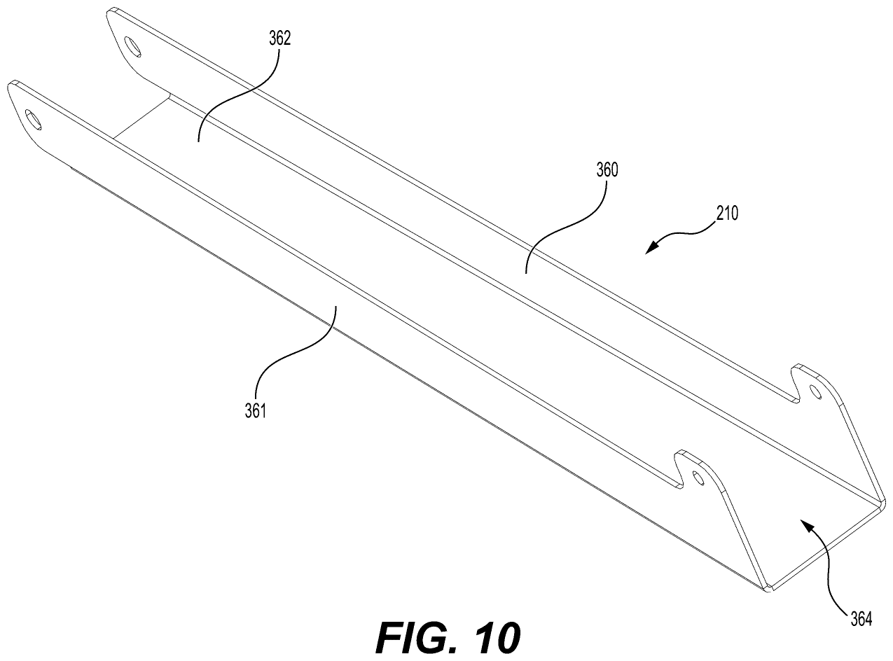

The stabilizing member 210 may also be referred to as a stabilizing leg or a stabilizing link. In the embodiment shown in FIG. 10, the stabilizing member 210 is formed from a C-shape channel 364 with its first end 212 pivotally connected to the inner end 214 of the base channel 200 and its second end 222 pivotally connected to the footplate 218 and the second end 216 of the lift leg 205. The C-channel forming the stabilizing member 210 includes upwardly projecting sidewalls 360 and 361 formed along opposite edges of a central web 362 to form a channel 364 therebetween. The channel 364 is longer and wider than the lift leg 205 such that the lift leg 205 may pivot into the channel 364 of the stabilizing member 210 when the lift leg 205 and the stabilizing member 210 are pivoted to a retracted position. The stabilizing member 210 is slightly narrower than the channel 230 in the base channel 200 so that when the stabilizing member 210 is pivoted to a retracted position, upper edges of the stabilizing member 210 sidewalls 360 and 361 engage the outer surface or periphery of the annular spacers 298 and 299 which protrude out from within the channel 230. The frictional engagement of the upper edges of the stabilizing member sidewalls 360 and 361 and the outer surface of the annular spacers 298 and 299 functions as a brake to resist rotation of the drive screw 204 to prevent or restrain advancement of the screw follower assembly 208 on the drive screw 204 thereby preventing inadvertent deployment of the stabilizing member 210 and lift leg 205 while the trailer is moving.

To lower the lift leg 205 and the stabilizing member 210, the drive screw 204 is rotated to drive the screw follower assembly 208 outward along the channel 230 which pushes or drives the first end 206 of the lift leg 205 outward. As the screw follower assembly 208 moves outward on the drive screw 204, the pivotal connection of the opposite ends of the stabilizing member 210 to the base channel 200 and the second end 216 of the lift leg 205 causes the second end 216 of the lift leg 205 to pivot downward increasing the angle between the lift leg 205 and the base channel 200. Similarly, as the screw follower assembly 208 moves inward on the drive screw 204, the pivotal connection of the opposite ends of the stabilizing member 210 to the base channel 200 and the second end 222 of the lift leg 205 causes the second end 222 of the lift leg 205 to pivot upward and the lift leg 205 to advance toward a horizontal alignment. The lift leg 205 is deployed by rotating the drive screw 204 to drive the screw follower assembly 208 further outward, and once the lift leg 205 is pivoted downward far enough to advance the foot pad 218 into engagement with the ground, further downward pivoting of the lift leg 205 causes the lift leg 205 to lift the jack 100 and the frame member 102 to which it is attached upward to remove the load from the frame member 102 on the vehicle suspension and lift the frame member 102 relative to the wheel (not shown) proximate the stabilizing jack 100. The length of the lift leg 205 is selected such that when the lift leg 205 extends vertically or perpendicular to the base channel 200 and contacts level ground on which the trailer is supported, the lift leg 205 raises the trailer frame member 102 to which it is attached a distance high enough to lift the frame member 102, so that it is supported on the lift leg 205, and not the suspension connecting the frame member 102 to the associated wheel.

In a preferred embodiment, and as best shown in FIG. 5, the annular stop 209 is sized to be engaged by the screw follower 208, to prevent further outward movement of the screw follower assembly 208 on the drive screw 204, when the lift leg 205 extends vertically or perpendicular to the base channel 200. It is also foreseen that the annular stop 209 could be replaced by a bolt, not shown, inserted through aligned bolt holes 370 formed in the sidewalls 224 and 225 of the base channel 200. The bolt holes 370 are positioned so that a bolt inserted therein is engaged by the annular spacers 298 and 299 of the screw follower assembly 208 when the screw follower assembly 208 has been advanced outward on the drive screw 204 to the point that the lift leg 205 extends perpendicular to the base channel 200. It is also foreseen that the length of the stabilizing member 210 relative to the length of the base channel 200 could be adjusted without using a stop so that when the screw follower assembly 208 is stopped from further outward advancement by the outer bearing plate 242 or other structure on the outer end of the base channel 200, the lift leg 205 extends perpendicular to the base channel 200.

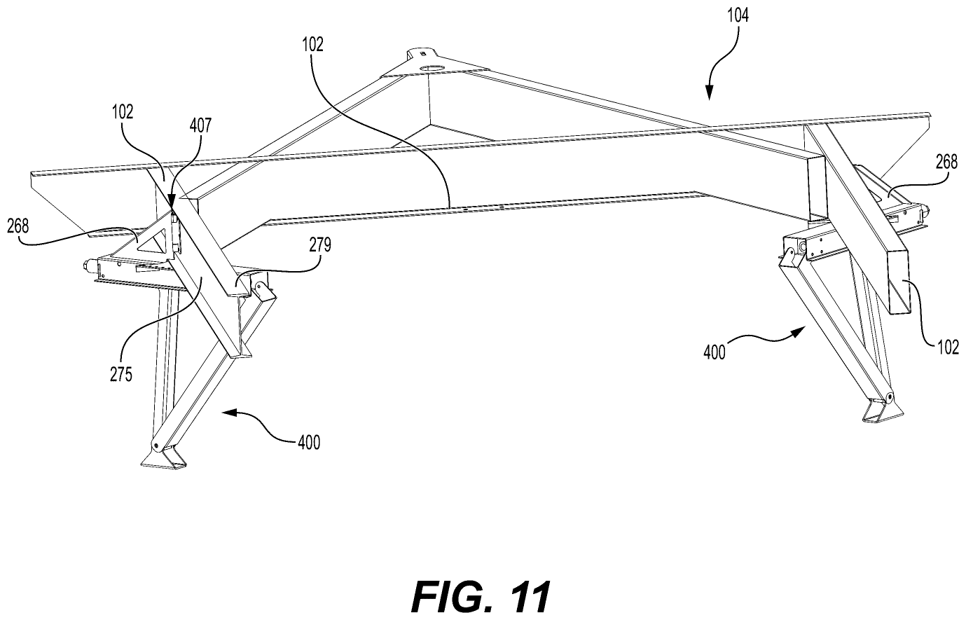

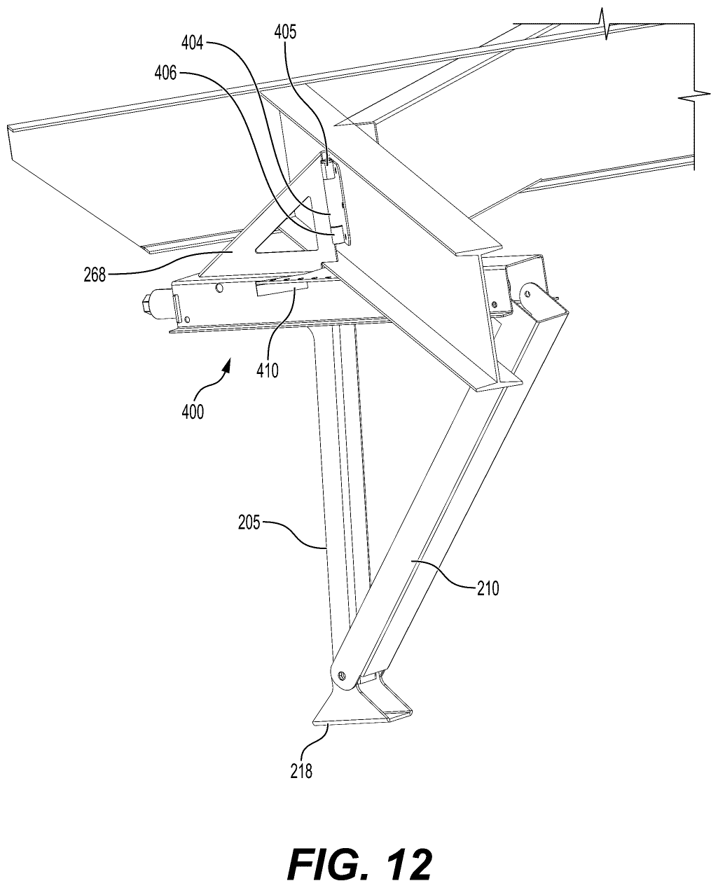

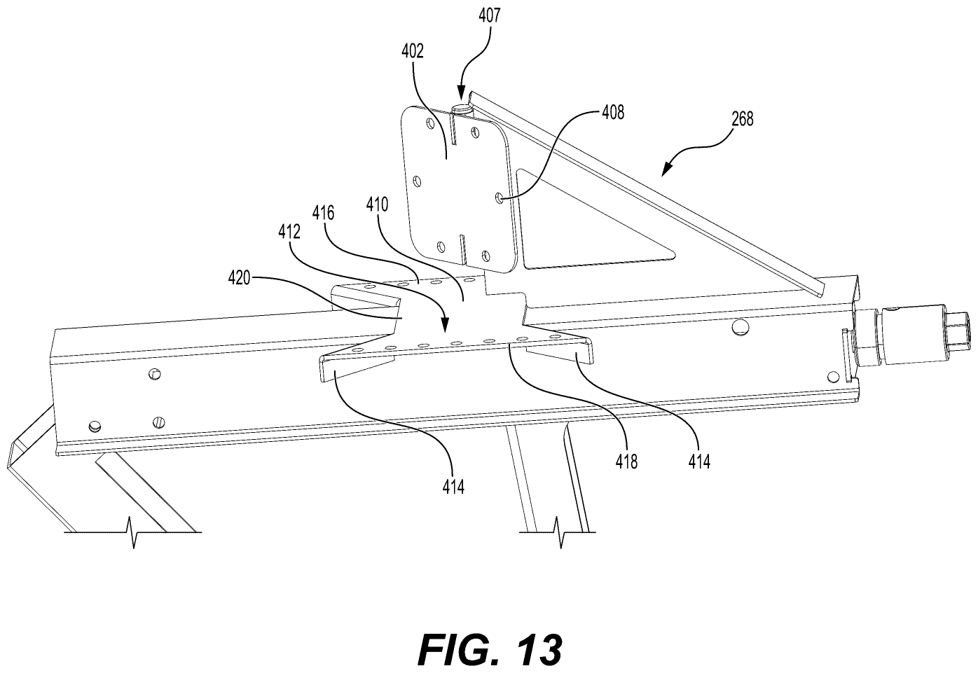

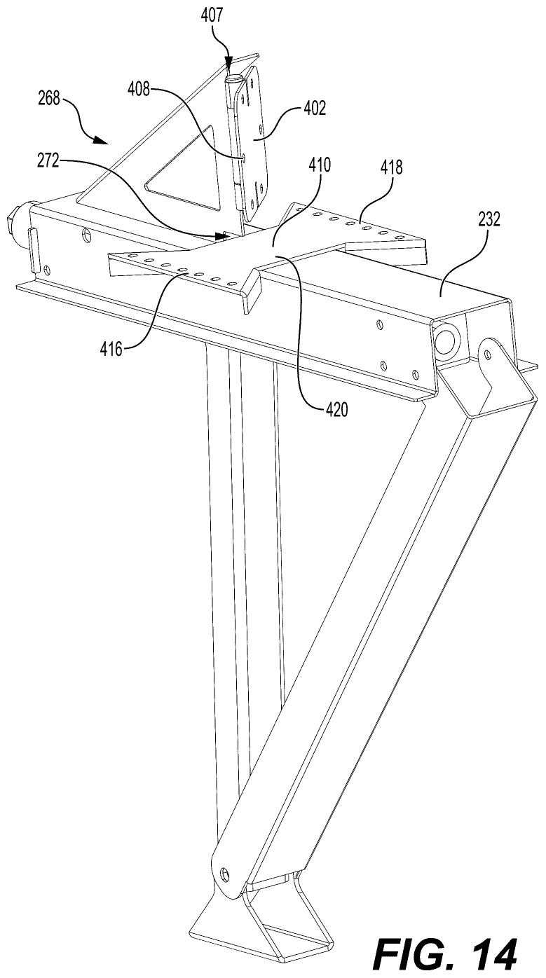

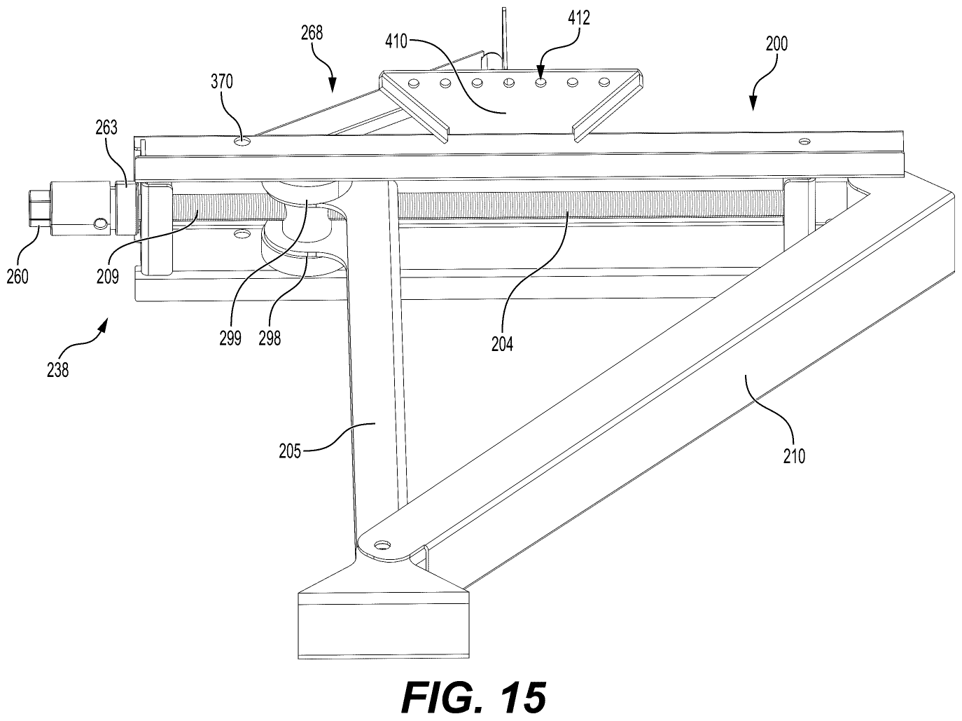

FIGS. 11-15 disclose an alternative embodiment of a stabilizing jack 400. Parts common to the stabilizing jack 100 and the stabilizing jack 400 are generally referred to with the same reference numbers. Similar to FIG. 1, FIG. 12 is illustrative of a portion of a trailer frame 104, for a travel trailer or other trailer, with frame members 102. The frame members 102 may be formed from different types of beams including I-beams and box beams as shown in embodiments with reference to FIG. 12. The stabilizing jack 400 includes a modified vertical mounting member or mounting plate 402. The vertical mounting plate 402 is pivotally connected to the brace 268 by a hinge 404 or other pivotal connection. Hinge 404 is connected to the vertical leg 270 of the brace 268. In the embodiment shown, the hinge 404 comprises a pair of hinge knuckles 405 welded or otherwise connected to the vertical leg 270 of brace 268 and a mating knuckle 406 welded to the back of the mounting member 402. Hinge knuckles 405 and hinge knuckle 406 are pivotably connected together by a hinge pin 407 extending through the aligned knuckles 405 and 406. Mounting holes 408 are formed in the mounting plate 402 such that a fastener, such as a bolt or screw may be inserted through the mounting holes 408 to fasten the mounting plate 402 to a vertical web or sidewall of a beam forming the frame member 102.

The stabilizing jack 400 shown includes a modified mounting plate 410. The mounting plate 410 is mounted on the top surface 232 of the base channel 200 in a similar position as the mounting plate 228 on stabilizing jack 100. In the embodiment shown, the mounting plate 410 is shaped with a geometry similar to an hourglass with opposing trapezoidal shaped end sections 416 and 418 connected by a rectangular cross-member 420 spanning across the top surface 232 of the web 223 of the base channel 200. Downwardly extending flanges 414 are formed along the inward sloping edges of the trapezoidal shaped sections of the mounting plate 228 similar to the flanges 248 of the mounting plate 228. Each end section 416 and 418 of the mounting plate 410 includes a plurality of fastener holes 412 extending through the mounting plate 410 proximate and along the outer edge thereof. The fastener holes 412 are sized to receive fasteners therethrough for securing the mounting plate 228 to the bottom of a frame member 102 or 103. The wider dimension of the outer end of each end section 416 and 418 allows for additional fastener holes 412 to be formed adjacent the outer end which allows the mounting plate to be rotated relative to the frame member to which it is attached at a plurality of angles at which at least one fastener hole 412 on each end sections 416 and 418 is positioned below the frame member 102 or 103 for fastening the mounting plate 410 thereto. It is foreseen that the end sections 416 and 418 may be formed in a variety of shapes, including for example, with a curved outer end adjacent to which the fastener holes 412 may be formed.

The hinge 404 allows the mounting plate 402 to pivot relative to the vertical leg 270 of the brace 268 and about an axis perpendicular to the base mounting bracket 410 and to the web 232 of the base channel 200 which allows the stabilizing jack 400 to be attached to the frame member 102 and extend laterally outward therefrom at one of a plurality of selected angles relative to a longitudinal axis of the frame member 102 including angles other than ninety degrees relative to the frame member 102. With reference to FIG. 12, rotation of the mounting plate 402 allows for the stabilizing jacks 400 to be mounted at an angle relative to the frame members 102 or 103, such as for example, at an angle of forty-five degrees relative to the frame members 102 or 103. As used herein, the angle at which the stabilizing jacks 400 are mounted relative to the frame members 102 and 103 corresponds to the angle between the longitudinal axis of the drive screw 204 relative to a longitudinal axis of the frame member 102 or 103 to which the jack 400 is mounted. Angling the stabilizing jacks 400 may provide additional stability to the trailer frame 104 when the jacks 400 are deployed and may be advantageous in other instances where it is preferable to align opposed stabilizing jacks 400 at a diagonal relative to the frame members 102 and 103 of the trailer frame 104.

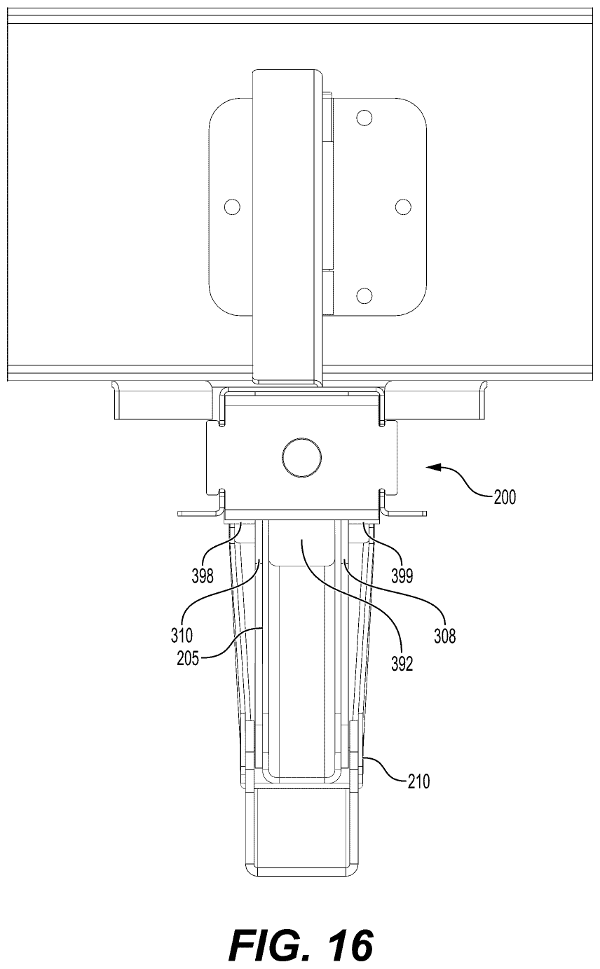

FIG. 16 discloses an alternative embodiment of the stabilizing jack wherein the stabilizing member 210 is shown wider at the upper end or end connected to the base channel 200 and the channel 200 may be wider than in the embodiments shown in FIGS. 1-15.

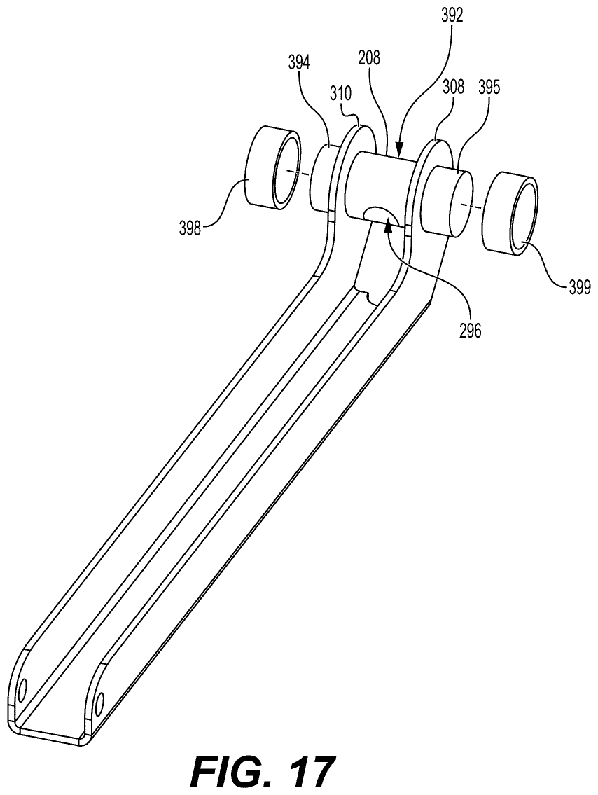

FIG. 17 discloses a modified embodiment of the lift leg 205 and screw follower assembly 208. The screw follower 208 or trunnion body 392 is cylindrical with a uniform diameter. Outer cylindrical ends 394 and 395, which may also be referred to as stub axles 394 and 395, extend through the holes formed in ears 308 and 310 of lift leg 205. Annular spacers 398 and 399 are supported on the outer cylindrical ends 394 and 395. Although the geometry of the outer surface of the spacers 398 and 399 is shown as round, it is foreseen that other geometries including square could be utilized as the spacers 398 and 399 do not need to function as rollers. When secured or positioned on the outer cylindrical ends 394 and 395, the annular spacers 398 and 399 extend between the respective ears 308 and 310 of the lift leg 205 and the sidewalls 224 and 225 of base channel 200. The spacers 398 and 399 prevent the left leg 205 shifting laterally within the channel 230 of base channel 205 maintaining the lift leg 205 aligned in the center of the channel 230 and preventing each of the ears 308 and 310 from advancing laterally on the cylindrical screw follower 208 and contacting the drive screw 204 extending through threaded hole 296 in the screw follower 208.

It is to be understood that while certain forms of the present invention have been illustrated and described herein, it is not to be limited to the specific forms or arrangement of parts described and shown. For example, it is to be understood that the stabilizing brace 268 could be used with a jack of a type in which the stabilizing member 210 is replaced by support arms or leg braces pivotally connected at one end to the base channel 200 and at the opposite end to lift leg 205 medially between the connection of the lift leg 205 to the screw follower assembly 208 and to the footplate 218. See, for example, the jack as shown in U.S. Pat. No. 4,103,869 of Mesny et al.

As used in the claims, identification of an element with an indefinite article “a” or “an” or the phrase “at least one” is intended to cover any device assembly including one or more of the elements at issue. Similarly, references to first and second elements is not intended to limit the claims to such assemblies including only two of the elements, but rather is intended to cover two or more of the elements at issue. Only where limiting language such as “a single” or “only one” with reference to an element, is the language intended to be limited to one of the elements specified, or any other similarly limited number of elements.

What is claimed is:

1. A stabilizing jack for a trailer, the stabilizing jack comprising:
a drive screw;
a base configured to support the drive screw and house a screw follower assembly threadingly coupled to the drive screw, the base including a support panel configured to be connected to a trailer frame member such that the support panel extends below and laterally relative to the frame member with the drive screw connected to and rotatably supported below the support panel;
a brace projecting upward from the support panel and configured to be fastened to a side of the trailer frame member;
a lift leg pivotally connected to the screw follower assembly; and
a stabilizing leg pivotally connected between the lift leg and the base.

2. The stabilizing jack of claim 1 wherein when the drive screw is rotated in a first direction, the screw follower assembly advances along the drive screw in a first direction and the lift leg extends downwards, and when the drive screw is rotated in a second direction, the screw follower assembly advances along the drive screw in a second direction and the lift leg retracts upwards.

3. The stabilizing jack of claim 1 wherein the base comprises first and second sidewalls extending downward from the support panel on opposite sides thereof.

4. The stabilizing jack of claim 1 wherein the brace comprises a mounting member fastenable to the side of the trailer frame member and a diagonal bracing member extending between the mounting member and the support panel of the base.

5. The stabilizing jack of claim 4 further comprising a notch formed between the support panel of the base and a lower end of the brace, the notch configured for receiving a portion of a flange of a beam forming the trailer frame member so that the mounting member of the brace may be positioned against a central web of the beam with the flange of the beam extending into the notch.

6. The stabilizing jack of claim 1 wherein the screw follower assembly comprises a cylindrical body having first and second stub axles projecting outward therefrom and on which first and second ears on an end of the lift leg are rotatably mounted.

7. The stabilizing jack of claim 6 further comprising first and second spacers mounted on a respective one of the first and second stub axles and positioned between respective ones of the first and second ears of the lift leg and first and second sidewalls of the base.

8. The stabilizing jack of claim 1 wherein the base comprises first and second sidewalls extending downward from the support panel on opposite sides thereof, and an inner bearing and an outer bearing plate extending in spaced apart relation proximate opposite ends of the support panel and extending below the support panel and between the first and second sidewalls.

9. The stabilizing jack of claim 1 further comprising an annular stop surrounding the drive screw between the screw follower assembly and the inner bearing.

10. The stabilizing jack of claim 4 wherein the mounting member of the brace is pivotable relative to the diagonal bracing member of the brace.

11. The stabilizing jack of claim 10 wherein the mounting member is pivotable about an axis extending perpendicular to the support panel of the base.

12. The stabilizing jack of claim 10 further comprising a base mounting bracket connected to the base and fastenable to a bottom of the trailer frame member at a plurality of selected angles relative to the trailer frame member to secure the base to the bottom of the trailer frame member at the plurality of selected angles relative to the trailer frame member.

13. A stabilizing jack, the stabilizing jack comprising:
a base wherein the base comprises a central web and sidewalls extending downward from the central web on opposite sides thereof;
a drive screw rotatably mounted within the base;
a screw follower assembly threadingly coupled to the drive screw;
a lift leg pivotally mounted to the screw follower assembly;
a stabilizing member pivotally connected at one end to the base and at a second end to the lift leg; and
a brace extending upward from the central web of the base, the brace having a mounting member fastenable to the side of a trailer frame member and a diagonal bracing member extending between the mounting member and the web of the base.

14. The stabilizing jack of claim 13 wherein when the drive screw is rotated in a first direction, the screw follower assembly advances along the drive screw in a first direction and the lift leg extends downwards, and when the drive screw is rotated in a second direction, the screw follower assembly advances along the drive screw in a second direction and the lift leg retracts upwards.

15. The stabilizing jack of claim 13 further comprising a notch formed between the web of the base and a lower end of the brace, the notch configured for receiving a portion of a flange of a beam forming the trailer frame member so that the mounting member of the brace may be positioned against a central web of the beam with the flange of the beam extending into the notch.

16. The stabilizing jack of claim 13 further comprising an annular stop surrounding the drive screw between the screw follower assembly and an inner bearing plate forming an end of the base.

17. The stabilizing jack of claim 13 wherein the screw follower assembly comprises a trunnion with a threaded hole extending through a trunnion body for threadingly coupling to the drive screw, the trunnion body having first and second stub axles projecting outward from the trunnion body on opposite sides thereof with first and second annular spacers rotatably mounted on the first and second stub axles respectively and the first and second annular spacers rollingly mounted within the sidewalls of the base.

18. The stabilizing jack of claim 15 wherein the brace includes a horizontal leg connected to and projecting upward from the central web of the base, a vertical leg projecting upward from the horizontal leg at an inner end thereof and a diagonal leg sloping downward from a peak of the vertical leg to an outer end of the horizontal leg and wherein the notch is formed in and extends into the horizontal leg from an inner end thereof and below the vertical leg.

19. The stabilizing jack of claim 17 wherein the lift leg includes first and second sidewalls projecting upward from a central web, wherein an upper surface of the first and second sidewalls engages the first and second annular spacers mounted on the screw follower when the stabilizing member is pivoted to a retracted position.

20. The stabilizing jack of claim 13 wherein the mounting member is pivotable about an axis extending perpendicular to the web of the base.
